(19) United States
(12) Patent Application Publication
(10) Pub. No.: US 2013/0151281 A1
(43) Pub. Date: Jun. 13, 2013

(54) METHODS AND SYSTEMS FOR MANAGING PRESCRIPTION LIABILITY

(71) Applicant: Express Scripts, Inc., St. Louis, MO (US)

(72) Inventors: Jennifer L. Kaburick, Glen Carbon, IL (US); Hollie Ann Bowyer, O'Fallon, MO (US); Lori T. Miller, St. Louis, MO (US); Colin T. Halloran, Lakeville, MN (US)

(73) Assignee: Express Scripts, Inc., St. Louis, MO (US)

(21) Appl. No.: 13/712,947

(22) Filed: Dec. 12, 2012

Related U.S. Application Data
(60) Provisional application No. 61/569,687, filed on Dec. 12, 2011.

(51) Int. Cl. G06F 19/00

(52) U.S. Cl. CPC G06F 19/328
USPC 705/2

(57) ABSTRACT

Methods and systems for managing prescription liability are described. In one embodiment, a reimbursement request for filling of a prescription drug on behalf of a worker is received. The reimbursement request is identified as being associated with a claim assumer. A determination that workers' compensation patient eligibility information is available for the worker is made. A modification notification including workers' compensation patient eligibility information associated with the worker is transmitted to a pharmacy administrative device. A replacement reimbursement request for filling of the prescription drug on behalf of the worker is received. The replacement reimbursement request is routed to a benefit manager device based on receipt of the replacement reimbursement request. Additional methods and systems are disclosed.

### CROSS-REFERENCE TO RELATED APPLICATIONS

This application claims priority under 35 U.S.C. §119(e) to U.S. Provisional Patent Application entitled “METHODS AND SYSTEMS FOR MANAGING PRESCRIPTION LIABILITY”, Ser. No. 61/569,687 filed on 12 Dec. 2011, the entire contents of the application is herein incorporated by reference.

### FIELD

This application generally relates to a system and method for managing prescription liability. More specifically, this application relates to managing payment associated with payment of workers' compensation prescription drug claims.

### BACKGROUND

An individual may have an accident at work and suffer an on-the-job injury (e.g., a head trauma injury). The injured worker may report the accident to his or her manager or a person in a human resources department. In conjunction with generating an accident report, an employer representative may provide the injured worker with eligibility information for processing medical and/or prescription drug claims associated with the injury. The injured worker may leave work, visit a doctor, obtain medical treatment including a prescription for medication associated with the treatment of the injury, and visit a pharmacy to obtain a prescription drug. The injured worker may or may not provide the doctor and/or the pharmacy with the appropriate eligibility information. The employer representative ultimately prepares and sends an accident report to an insurance company that handles the workers' compensation injuries on behalf of the employer.

### BRIEF DESCRIPTION OF THE DRAWINGS

FIG. 1 is a block diagram of an example system, according to an example embodiment;

FIG. 1 is a block diagram of an example system, according to an example embodiment;

FIG. 2 is a block diagram of an example pharmacy administrative device that may be deployed within the system of FIG. 1, according to an example embodiment;

FIG. 3 is a block diagram of an example benefit manager device that may be deployed within the system of FIG. 1, according to an example embodiment;

FIG. 4 is a block diagram of an example switching company device that may be deployed within the system of FIG. 1, according to an example embodiment;

FIG. 5 is a block diagram of an example pharmacy administrative subsystem that may be deployed within the pharmacy administrative device of FIG. 2, according to an example embodiment;

FIG. 6 is a block diagram of an example benefit manager subsystem that may be deployed within the benefit manager device of FIG. 3, according to an example embodiment;

FIG. 7 is a block diagram of an example switching subsystem that may be deployed within the switching company device of FIG. 4, according to an example embodiment;

FIGS. 8 and 9 are example process flows illustrating methods for prescription process, according to example embodiments;

FIG. 10 in an example process flow illustrating a method for claim reimbursement, according to an example embodiment;

FIGS. 11 and 12 are example process flows illustrating methods for reimbursement routing, according to example embodiments;

FIG. 13 is an example first fill form, according to an example embodiment;

FIG. 14 is an example pharmacy letter, according to an example embodiment;

FIG. 15 is an example injured worker letter, according to an example embodiment;

FIG. 16 is an example liability assumer letter, according to an example embodiment;

FIG. 17 is an example injured worker ID card, according to an example embodiment;

FIG. 18 is a block diagram of a machine in the example form of a computer system within which a set of instructions may be executed or stored for causing the machine to perform any one or more of the methodologies discussed herein.

### DETAILED DESCRIPTION

Example methods and systems for managing liability for prescriptions are described. In the following description, for purposes of explanation, numerous specific details are set forth in order to provide a thorough understanding of example embodiments. It will be evident, however, to one of ordinary skill in the art that embodiments of the invention may be practiced without these specific details.

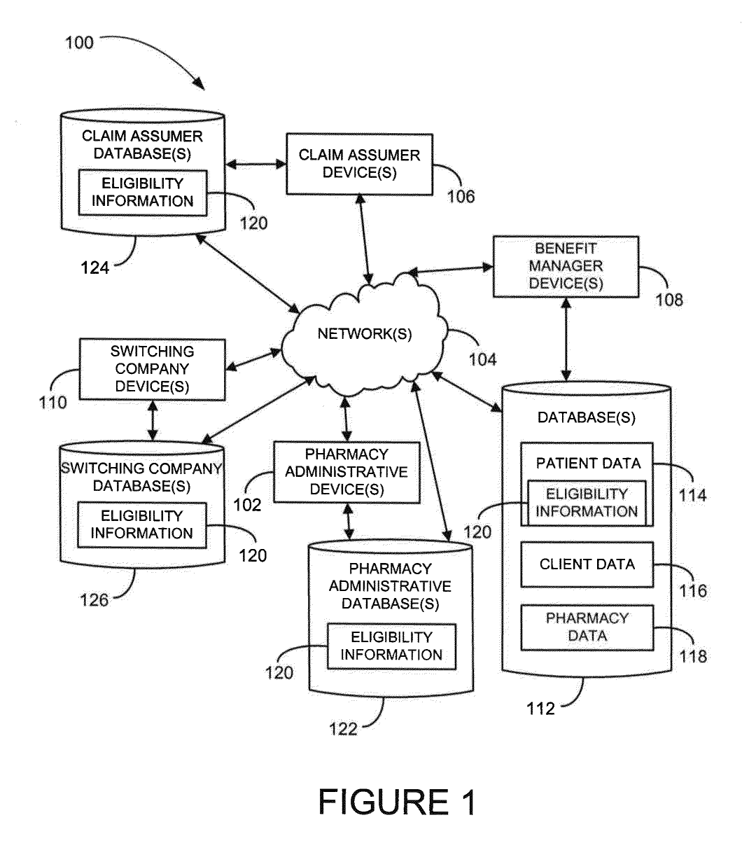

FIG. 1 is a block diagram of an example system 100, according to an example embodiment. The system 100 is an example environment in which prescription liability may be managed. The system 100 includes a pharmacy administrative device 102 in communication with a claim assumer device 106, a benefit manager device 108, and a switching company device 110 over a network 104.

The pharmacy administrative device 102 is a device operated by a prescription fulfillment entity at least partially responsible for the fulfillment of a prescription for prescription drugs. In some embodiments, the prescription fulfillment entity operating the pharmacy administrator device 102 is or associated with a single retail pharmacy or multiple retail pharmacies. In some embodiments, the prescription fulfillment entity operating the pharmacy administrator device 102 is or associated with a single mail order pharmacy or multiple mail order pharmacies. In general, a pharmacy that fills a prescription on behalf of the prescription fulfillment entity is referred to as a filling pharmacy. In some embodiments, the prescription fulfillment entity may by a centralized organization for addressing the liability for prescriptions fulfilled by multiple retail or mail order pharmacies. The pharmacy administrator device 102 may be a networked device such as a server, a client computer, a personal computer (PC), a tablet PC, a Personal Digital Assistant (PDA), a mobile telephone, a web appliance, or the like.

The network 104 may include, by way of example, Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof. Network 104 may also include optical communications. Other conventional and/or later developed wired and wireless networks may also be used.

The switching device 110 is a device operated by a switching entity at least partially responsible for routing a prescription between the pharmacy administrative device 102 and the claim assumer device 106 and/or the benefit manager device 108. An example of such a switching entity or switching company is Relay Health, Inc. of Atlanta, Ga.

In some embodiments, the switching entity is responsible for delegating liability for the prescription. Liability generally relates to partial or full financial obligation(s). Prescription liability generally refers to a partial or full financial obligation(s) for at least a portion of the payment for fulfillment of a prescription drug. In some embodiments, the switching entity is responsible for routing claims.

The switching device 110 of the system 100 is in communication with a claim assumer device 106 and the benefit manager device 108 via the network 104.

The claim assumer device 106 is a device operated by a claim assumption entity at least partially responsible for temporarily assuming liability for prescriptions and passing the liability on to other associated entities. The claim assumption entity may pay the prescription fulfillment entity for filling a prescription when the party responsible for ultimately paying for a prescription is unknown.

The benefit manager device 108 is a device operated by a benefit manager or, more in some embodiments, a benefit manager that provides a pharmacy benefit for at least workers' compensation claims. Further, in some embodiments, the benefit manager device 106 may be operated by other entities.

In general, a client or payor engages a benefit manager that includes a pharmacy benefit or a pharmacy benefit manager (PBM) to offer a drug benefit program. Examples of clients include governmental organizations (e.g., Federal government agencies, the Department of Defense, the Centers for Medicare and Medicaid Services and state government agencies), middle market companies, large national employers, health insurance companies that have carved out the drug benefit, and the like. A person who is a participant or member of a drug benefit program offered by the client may obtain prescription drugs according to pricing, pharmacy selection, rebates, discounts and the like provided by the terms of the drug benefit program.

The client's offered drug benefit program may be a stand-alone drug benefit operated by the PBM, or as part of a health care benefit operated by a health insurance company where the PBM services are offered directly by the health insurance company or offered indirectly by the PBM on behalf of the health insurance company. In various embodiments, the PBM may be the same entity as the mail order pharmacy, the PBM may be an entity related to the mail order pharmacy (e.g., through partial or complete common control, partial or complete common ownership or the like), and/or the PBM may be separate and discrete entity from the mail order pharmacy.

Some of the operations of the PBM may include the following. A patient (e.g., of a pharmacy) or a person act on behalf of the patient attempts to obtain a prescription drug at a retail pharmacy location of a pharmacy where the patient can obtain drugs in a physical store from a pharmacist or pharmacist technician. The pharmacy can be associated with a single retail pharmacy location, or can be a pharmacy chain that includes multiple retail pharmacy locations. The pharmacy then submits a claim to the PBM. The PBM performs certain adjudication functions including verifying the eligibility of the member, reviewing the formulary to determine appropriate co-pay, coinsurance, and deductible for the prescription drug, and performing a drug utilization review (DUR) on the member. The PBM then adjudicates the claim associated with the prescription drug and provides a response to the pharmacy following performance of the aforementioned functions. As part of the adjudication, the client (or the PBM on behalf of the client) ultimately reimburses the pharmacy for filling the prescription drug when the prescription drug was successfully adjudicated.

Another basis for the amount of reimbursement paid by PBMs may be the way in which the request for reimbursement reached the PBM for adjudication. In some states and other jurisdictions, the law mandates that a prescription must be fulfilled at the time of intake. That is, the pharmacy cannot wait for adjudication by the PBM and must fulfill the prescription without payment or any guarantee of payment from a PBM or the patient. In such cases (e.g., workers' compensation claims for prescription drugs), the prescription may reach the PBM through the claim assumer (e.g., as may operate the claim assumer device 106). Specifically, a third-party biller or claim assumer assumes liability for the prescription, sometimes through an intermediary (e.g., the entity operating the switching company device 110), and pays the pharmacy for the fulfillment of the prescription, thereby assuming prescription liability. Using the claim assumer device 106 and other services, the claim assumer attempts to associate the prescription with a payor or a worker's compensation benefit from which the patient is eligible to receive pharmacy benefits from the PBM. The claim assumer then transfers prescription liability to the PBM in exchange for reimbursement. The claim assumer may charge a premium above the pharmacy's charge for the use of the claim assumer device 108 and/or for assuming the risk of not finding that payor or plan from which the patient is eligible for pharmacy benefits.

The benefit management device 106 may be in communication directly (e.g., through local storage) and/or through the network 104 (e.g., in a cloud configuration or software as a service) with a benefit manager database 112. The benefit manager database 112 may store patient data 114, client data 116, and/or pharmacy data 118.

The patient data 114 includes information regarding the patients associated with the prescription network manager and the benefit manager device 108. Examples of the patient data 114 include name, address, telephone number, patient identification number, e-mail address, prescription drug history, and the like. The patient data 114 may include a client identifier that identifies the client associated with the patient and/or a patient identifier that identifies the patient to the client.

The client data 116 includes information regarding the clients of the network manager. Examples of the client data 116 include company name, company address, contact name, contact telephone number, contact e-mail address, and the like.

The pharmacy data 118 includes information regarding pharmacies. The pharmacy data 118 may include, by way of example, location data regarding the location of the pharmacies, information data regarding the pharmacy hours and/or telephone number, pharmacy network association data defining the pharmacy network associations of which the pharmacies are associated, and the like.

In addition to the benefit manager database 112, the pharmacy administrative device 102 may be in communication with a pharmacy administrative database 122, the claim assumer device may be in communication with a claim assumer database 124, and/or the switching company device 110 may be in communication with a switching company database 126. Each of the respective entities may maintain its own version of eligibility information 120 including, in some embodiments, some portion of workers' compensation eligibility information.

While the system 100 in FIG. 1 is shown to include single devices 102, 106, 108, 110 multiple devices may be used. The devices 102, 106, 108, 110 may be the same type of device or may be different device types. When multiple devices are present, the multiple devices may be of the same device type or may be a different device type. Moreover, system 100 shows a single network 104, however, multiple networks can be used. The multiple networks may communicate in series with each other to link the devices 102, 106, 108, 110 or in parallel to link to one or multiple of the other devices 102, 106, 108, 110.

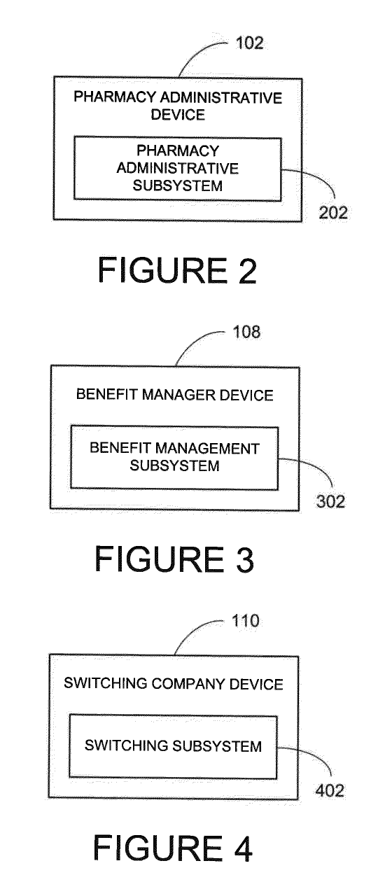

FIG. 2 illustrates the pharmacy administrative device 102, according to an example embodiment. The pharmacy administrative device 102 may be deployed in the system 100, or may be otherwise used. The pharmacy administrative device 102 may include the pharmacy administrative subsystem 202 to process prescriptions.

FIG. 3 illustrates the benefit manager device 108, according to an example embodiment. The benefit manager device 108 may be deployed in the system 100, or may be otherwise used. The benefit manager device 108 may include the benefit management subsystem 302 to reimburse claims.

FIG. 4 illustrates the switching company device 110, according to an example embodiment. The switching company device 110 may be deployed in the system 100, or may be otherwise used. The switching company device 110 may include the switching subsystem 402 to route reimbursement.

The system 100 and its various elements may be used for reimbursing claims associated with workers compensation as follows. An individual incurs a work-related injury that qualifies, or may qualify, for workers' compensation. In obtaining treatment for the work-related injury, a doctor or other prescriber may issue a prescription for a medication to treat the injured worker's work-related injury. The prescription may be issued electronically and transmitted to a selected filling pharmacy (e.g., through a transmission via the network 104 to the pharmacy administrative device 102), provided to the injured worker as a paper prescription, or otherwise issued by the prescriber.

When the injured worker visits a pharmacy (e.g., tied to, coupled with, or otherwise associated with the pharmacy administrative device 102) to obtain fulfillment of the prescription, the patient should not present the worker's prescription drug benefit card or otherwise use the patient's prescription drug benefit plan. As the need for the prescription drug relates to a work-related injury, the financial responsibility for the prescription medication is with a payer (e.g., a company at which the injured worker is employed and/or an insurance company providing workers' compensation insurance on behalf of the company). The workers' compensation prescription is not processed (e.g., by the benefit manager of the employer) under the patient's prescription drug plan under which the patient typically has some associated financial responsibility (e.g., in the form of a co-pay). Rather, the prescription drug is paid under a workers' compensation benefit on behalf of the injured worker's company such that the injured worker is typically not responsible for payment of a co-pay to receive the prescription drug.

The eligibility information 120 available to a filling pharmacy (e.g., as stored in the pharmacy administrative database 122) typically is different with workers' compensation prescription drug claims. When a prescription drug is processed (e.g., be the benefit manager) under the injured worker's prescription drug benefit, pharmacies typically have eligibility information that identifies various individuals and their associated benefit managers and/or payors. Thus, the pharmacies typically have the information needed to coordinate with others (e.g., a benefit manager and/or payor) to process and fulfill the prescriptions of various patients of the pharmacy. However, pharmacies do not typically have eligibility information 120 associated with injured workers and/or workers that may become injured during employment by a company. Pharmacies typically lack such information as not all workers of employers will incur a workers' compensation injury that necessitates the need for fulfillment of a prescription drug.

If the injured worker has workers' compensation claim eligibility information in the form of a card or otherwise and remembers to provide the workers' compensation claim eligibility information to the filling pharmacy, or if worker's compensation eligibility information for the patient already exists in the filling pharmacy's systems for the injured worker (e.g., as part of the eligibility information 120 available to the filling pharmacy through the pharmacy administrative database 122), the filling pharmacy will request reimbursement from a benefit manager associated with the workers' compensation prescription drug claims or, if not known, a payor. In some embodiments, the reimbursement request may be transmitted by the pharmacy administrative device 102 to the benefit manager device 108 via the network 104.

If the injured worker does not have workers' compensation claim eligibility information, fails to present the workers' compensation claim eligibility information to the filling pharmacy, or a query of the pharmacy administrative database 122 does not identify workers' compensation eligibility information for the injured worker among the eligibility information 120, the filling pharmacy still fills the prescription drug for the injured worker. However, the filling pharmacy then seeks reimbursement from a potentially unknown responsible party after prescription drug fulfillment.

Because of the uncertainty surrounding the identity of the unknown payor and/or benefit manager, the risk of potential nonpayment for the prescription drug by the payor and/or benefit manager, the desire for the filling pharmacy to be quickly reimbursed for fulfillment of the prescription drug, and/or other reasons, the filling pharmacy may sell the right to be reimbursed for the prescription drug to a claim assumer or third party biller. The filling pharmacy may take a discount on what it may (or potentially could) obtain in reimbursement for the prescription drug by accepting payment from the claim assumer. In certain instances, the filling pharmacy may obtain higher reimbursement than it would otherwise receive if the payor and/or benefit manager were known.

After obtaining ownership of the prescription or script through the right to be reimbursed for its filling, the claim assumer seeks to identify the payor and/or benefit manager associated with the injured worker. In some embodiments, the claim assumer may utilize the claim assumer device 106 to query various benefit managers, payors, or the like in an attempt to identify the payor and/or benefit manager associated with the injured worker. Once the responsible party is identified, the claim assumer sends a request for payment for the prescription drug to the identified payor and/or benefit manager. In some embodiments, the request for reimbursement is transmitted from the claim assumer device 106 to the benefit manager device 108.

The identified payor (or the benefit manager on behalf of the payor) reimburses the claim assumer for script fulfillment. Typically, the reimbursement paid to the claim assumer is higher than the payor would otherwise be responsible for reimbursing because the prescription drug was not provided in accordance with the payor's agreed upon pharmacy discounts. In addition, the prescription drug may not ordinarily be available to the injured worker due to availability of generics, other medications that similarly treat the same condition, and other features of a benefit plan design of the workers' compensation benefit of the injured worker's employer. In some embodiments, reimbursement is facilitated through the benefit manager device 108.

Once the benefit manager receives the request for reimbursement from the claim assumer (e.g., through receipt of the reimbursement request by the benefit manager device 108), the benefit manager (e.g., through operations performed on the benefit manager device 108) identifies the pharmacy that fulfilled the prescription drug and requests that the pharmacy update its workers' compensation patient eligibility information of the injured worker. The benefit manager may send requests one at a time for the pharmacy to update its workers' compensation patient eligibility information of a particular patient, or may send a request including the workers' compensation patent eligibility information for multiple patients. In some embodiments, the request is in the form of a transmission of workers' compensation eligibility information from the benefit manager device 108 to the pharmacy administrative device 102).

Once the workers' compensation patient eligibility information is updated (e.g., via updating the eligibility information stored in the pharmacy administrative database 122), the patient next seeks fulfillment of an additional medication (e.g., a new prescription or a renewal prescription) associated with the workers' compensation injury, the filling pharmacy will seek reimbursement from the benefit manager and/or payor without interfacing with the third party biller.

In some embodiments, a switching company receives a request for reimbursement including a prescription drug claim submitted to the filling pharmacy. In one embodiment, the reimbursement request is received on the switching company device 110 via the network 104. Such claim may be submitted electronically by the filling pharmacy for adjudication or partial adjudication (e.g., reimbursement). The switching company identifies (e.g., through operations performed on the switching company device 110) a target for the request based on an identifier included with the request. While the identifier is typically a Bank Identifier Number (BIN), other types of identifiers may be used. The BIN (or other identifier) is typically used by the switching company to, among other things, transmit the prescription drug claim to the identified target. The identifier may include, by way of example, numbers, alphabetical characters, other characters, or combinations thereof. In one embodiment, the BIN includes a five digit number.

In some embodiments, the benefit manager may provide workers' compensation eligibility information to the switching company. In one embodiment, the workers' compensation eligibility information is transmitted to the switching device company 110 via the network 104. The switching company may, through operations performed on the switching company device 110, identify workers' compensation claims for which the payor and/or benefit manager is unknown and may be directed to a third party biller using the BIN. The identification may be performed by the switching company by matching the BIN with the BINs of known third party billers. The switching company may then, through operations performed on the switching company device 110, modify the request based on the workers' compensation eligibility information associated with the injured worker so that the request is provided to the payor and/or benefit manager and not the third party biller. The modification may include altering the BIN and routing the claim based on the altered BIN, maintaining the received BIN but routing the request in accordance with a different BIN (e.g., of the claim administrator), or otherwise.

The modification to the request may occur after the injury by the injured worker but prior to filling or dispensing the prescription drug associated with the treatment of the injury, after a first fill of the prescription drug associated with the treatment of the injury but prior to the second fill of the prescription drug and/or a first fill of an additional prescription drug for the injured worker, or at another time.

In some embodiments, the modification may occur after the filling pharmacy has been provided notice (e.g., by the benefit manager) of the workers' compensation eligibility information. The notification may occur electronically through a transmission over the network 104, telephonically, through a mailed or faxed letter, or otherwise. The notification may include the names and/or identifiers of injured worker(s) that have received prescription drugs under the workers' compensation drug benefit from the filling pharmacy. The filling pharmacy may update its workers' compensation eligibility information in response to the notification (e.g., by modifying the eligibility information 120 stored in the pharmacy administrative database 122). The update may occur automatically through a data feed (e.g., between the benefit manager device 108 and the pharmacy administrative device 102), manually through a technician or other person entering the updated information into the pharmacy administrative device 102, or otherwise. When the filling pharmacy is delayed in updating its workers' compensation eligibility information, the modification may prevent further prescription drug fulfillment for which reimbursement is sought from third party biller instead of the benefit manager (or payor).

In some embodiments, the switching company may provide notice to the filling pharmacy of the workers' compensation eligibility information of a single injured worker (e.g., in response to a request associated with the injured worker) or multiple injured workers (e.g., in bulk based on all workers' compensation eligibility information received during a certain time period). In one embodiment, the notice may include a transmission from the switching company device 110 to the pharmacy administrative device 102 via the network 104.

In some embodiments, the switching company may include with the notice a request to update the eligibility information of the injured worker and that the filling pharmacy is to submit the claim again once updated. In these embodiments, the filling pharmacy may make the modification (e.g., through operations performed on the pharmacy administrative device 102) in response to the notification provided by the switching company. In some embodiments, the switching company may automatically provide a feed into the pharmacy administrative device 102 to update the workers' compensation eligibility information.

In some embodiments, the benefit manager (or payor) provides reimbursement to the switching company and/or the filling pharmacy for the modifications that were made to enable processing of the workers' compensation prescription claim by the benefit manager (or payor). The reimbursement may be provided directly by the benefit manager device 108, based on instructions issued by the benefit manager device 108, or otherwise.

In some embodiments, the benefit manager (or payor) may provide a notification to the injured worker regarding the claim submitted without the workers' compensation eligibility information. The notification may include the workers' compensation eligibility information of the injured worker (e.g., a BIN). An example of such notification is provided below.

In some embodiments, the notification provided to the pharmacy and/or injured worker by the benefit manager may include a benefit card. The card may include at least some of the workers' compensation eligibility information of the injured worker. An example of a benefit card provided to the injured worker is provided below.

In some embodiments, the switch company is RelayHealth Corp. owned by McKesson Technology Solutions. In general, a switching company is a company that receives transactions from providers and intermediaries as they pass these requests from providers to adjudicators. Switching companies often perform format conversions and perform pre-edits, then return an approved or denied response to the provider after verifying eligibility. The reply from the adjudicator may also pass through the switching company on its return response to the provider.

The switch company is provided patient level data by the benefit manager. Before the switch company routes the scripts, the switch company will check eligibility and route to benefit manager as appropriate.

The switch company has a database of identifiers associated with third party billers and patient eligibility data including an association with a benefit manager. The identifiers for the third party billers and benefit managers will also be associated with routing information so that the requests can be routed appropriately. The switching company may also have a database of employers that are associated with payers.

In some embodiments, the methods and systems reduce the costs to the payor for the prescription drugs associated with workers' compensation claims.

In some embodiments, the methods and systems reduce the reliance or need for a filling pharmacy to sell a workers' compensation claim to a claim assumer.

In some embodiments, the methods and systems reduce or eliminate the need to include a claim assumer in the process of claim reimbursement of workers' compensation prescription drug claims.

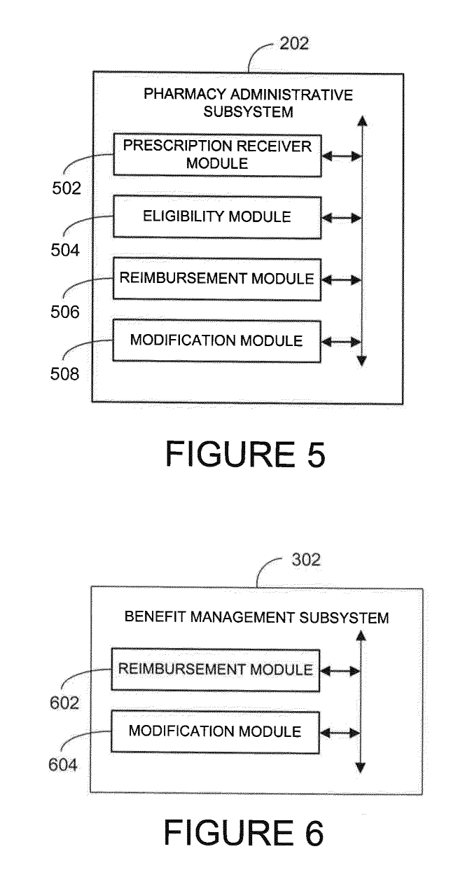

FIG. 5 illustrates an example pharmacy administrative subsystem 202 that may be deployed in the pharmacy administrative device 102, or otherwise deployed in another system. One or more modules are communicatively coupled and included in the pharmacy administrative subsystem 202 to process prescriptions. The modules of the pharmacy administrative subsystem 202 that may be included are a prescription receiver module 502, an eligibility module 504, a reimbursement module 506, and a modification module 508. Other modules may also be included.

In some embodiments, the modules of the pharmacy administrative subsystem 202 may be distributed so that some of the modules are deployed in the pharmacy administrative device 102 and some modules are deployed in the claim assumer device 106, the benefit manager device 108, and/or the switching company device 110. In one embodiment, the modules are deployed in memory and executed by a processor coupled to the memory. The functionality contained within the modules 502-508 may be combined into a lesser number of modules, further divided among a greater number of modules, or redistributed among existing modules. Other configurations including the functionality of the modules 502-508 may be used.

In some embodiments, the prescription receiver module 502 receives a prescription for a prescription drug to treat a worker for a work-related injury. The eligibility module 504 determines that there is no available workers' compensation patient eligibility information associated with the worker.

The reimbursement module 506 transmits a reimbursement request for filling of the prescription drug to the claim assumer device 106.

The modification module 508 receives a modification notification from the switching company device 110 in response to transmission of the reimbursement request. The modification notification may include workers' compensation patient eligibility information associated with the worker.

The eligibility module 504 updates workers' compensation patient eligibility information associated with the worker in response to receipt of the modification notification. The updated workers' compensation patient eligibility information may reflect a benefit manager to process workers' compensation claims.

The reimbursement module 506 transmits a substitute reimbursement request for the prescription drug to the benefit manager device 108. The reimbursement module 506 may then receive reimbursement for the prescription drug in response to transmission of the substitute reimbursement request.

In some embodiments, the prescription receiver module 502 receives a prescription for a prescription drug to treat a worker for a work-related injury. The eligibility module 504 determines that there is no available workers' compensation patient eligibility information associated with the worker.

The reimbursement module 506 transmits, using an identifier associated with a claim claim assumer, a reimbursement request for filling of the prescription drug. The reimbursement module 506 may then receive reimbursement for the prescription drug in response to transmission of the reimbursement request using the identifier associated with the claim assumer.

After transmission of the identifier associated with the claim assumer, the modification module 508 receives a modification notification from the benefit manager device 108 to include workers' compensation patient eligibility information associated with the worker.

The eligibility module 504 automatically updates workers' compensation patient eligibility information associated with the worker in response to receipt of the modification notification. The updated workers' compensation patient eligibility information may reflect the benefit manager to process workers' compensation claims.

The prescription receiver module 502 may then receive an additional prescription for a new additional prescription drug or a renewal of the prescription drug to treat the worker for the work-related injury. In some embodiments, the additional prescription is prescribed after the prescription.

The reimbursement module 506 transmits, using an identifier associated with the benefit manager, a reimbursement request for filling of the new additional prescription drug or the renewal of the prescription drug. The reimbursement module 506 then receives reimbursement for the new additional prescription drug or the renewal of the prescription drug in response to transmission of the reimbursement request using the identifier associated with the benefit manager.

FIG. 6 illustrates an example benefit management subsystem 302 that may be deployed in the pharmacy administrative device 102, or otherwise deployed in another system. One or more modules are communicatively coupled and included in the pharmacy administrative subsystem 202 to reimburse claims (e.g., pharmacy claims for reimbursement of fills of prescription drugs). The modules of the benefit management subsystem 302 that may be included are a reimbursement module 602 and a modification module 604. Other modules may also be included.

In some embodiments, the modules of the benefit management subsystem 302 may be distributed so that some of the modules are deployed in the benefit manager device 108 and some modules are deployed in the pharmacy administrative device 102, the claim assumer device 106, and/or the switching company device 110. In one embodiment, the modules are deployed in memory and executed by a processor coupled to the memory. The functionality contained within the modules 602-604 may be combined into a lesser number of modules, further divided among a greater number of modules, or redistributed among existing modules. Other configurations including the functionality of the modules 602-604 may be used.

The reimbursement module 602 receives, from the claim assumer device 106, a reimbursement request for filling of a prescription drug to treat a worker for a work-related injury.

The reimbursement module 602 may then provide reimbursement to the claim assumer associated with the claim assumer device 106. The claim assumer may have been reimbursed at a first reimbursement rate. A filling pharmacy associated with a pharmacy administrative device 102 may have filled the prescription drug having been reimbursed from the claim assumer at a second reimbursement rate. In some embodiments, the first reimbursement rate is higher than the second reimbursement rate.

After receiving the reimbursement request, the modification module 604 transmits a modification notification including workers' compensation patient eligibility information associated with the worker to the pharmacy administrative device 102. In some embodiments, the pharmacy administrative device 102 is capable of automatically updating workers' compensation patient eligibility information associated with the worker in response to receipt of the modification notification. The updated workers' compensation patient eligibility information may then reflect the benefit manager to process workers' compensation claims.

The reimbursement module 602 receives, using an identifier associated with the benefit manager, a reimbursement request for filling of a new additional prescription drug or a renewal of the prescription drug to treat the worker for the work-related injury. The reimbursement module 602 may then provide reimbursement for the new additional prescription drug or the renewal of the prescription drug in response to receipt of the reimbursement request using the identifier associated with the benefit manager.

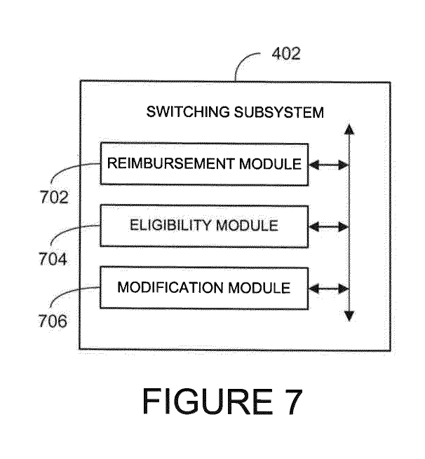

FIG. 7 illustrates an example switching subsystem 402 that may be deployed in the switching company device 110, or otherwise deployed in another system. One or more modules are communicatively coupled and included in the switching subsystem 402 to route reimbursement. The modules of the switching subsystem 402 that may be included are a reimbursement module 702, an eligibility module 704, and a modification module 706. Other modules may also be included.

In some embodiments, the modules of the switching subsystem 402 may be distributed so that some of the modules are deployed in the switching company device 110 and some modules are deployed in the pharmacy administrative device 102, the claim assumer device 106, and/or the benefit manager device 108. In one embodiment, the modules are deployed in memory and executed by a processor coupled to the memory. The functionality contained within the modules 702-706 may be combined into a lesser number of modules, further divided among a greater number of modules, or redistributed among existing modules. Other configurations including the functionality of the modules 702-706 may be used.

In some embodiments, the reimbursement module 702 receives a reimbursement request for filling of a prescription drug on behalf of a worker. The received reimbursement request may seek to properly assign prescription liability and thereby seek reimbursement from the benefit manager and/or the payor. The reimbursement module 702 then identifies the reimbursement request as being associated with a claim assumer.

The eligibility module 704 determines that workers' compensation patient eligibility information is available for the worker. The modification module 706 transmits a modification notification including workers' compensation patient eligibility information associated with the worker to the pharmacy administrative device 102.

The reimbursement module 702 receives a replacement reimbursement request for filling of the prescription drug on behalf of the worker. The reimbursement module 702 then routes the replacement reimbursement request to the benefit manager device 108 based on receipt of the replacement reimbursement request.

In some embodiments, the reimbursement module 702 receives a reimbursement request for filling of a prescription drug on behalf of a worker. The reimbursement request may include a claim reimbursement responsibility identifier. The reimbursement module 702 may then identify the claim reimbursement responsibility identifier of the reimbursement request as being associated with a claim assumer.

The eligibility module 704 determines that workers' compensation patient eligibility information is available for the worker. The eligibility module 704 may then identify the claim reimbursement responsibility identifier associated with the benefit manager based on the workers' compensation patient eligibility information associated with the worker.

The modification module 706 modifies the reimbursement request including the claim reimbursement responsibility identifier to reflect that the reimbursement request includes a benefit manager identifier. The reimbursement module 702 then routes the replacement reimbursement request to the benefit manager device 108 associated with the benefit manager based on a modification to the reimbursement request.

In some embodiments, the eligibility module 704 enables the switching subsystem 402 to determine eligibility of the injured worker to receive pharmacy benefits from a benefit manager responsible for administering the pharmacy benefits (e.g. a benefit operating the prescription manager device 110).

In some embodiments, the eligibility module 704 may have real-time access to the switching company database 124 and/or or portions of the patient data 114 and/or client data 114 of the benefit manager database 112. In one embodiment, the eligibility module 704 determines eligibility by comparing the patient data 114 and/or the client data 116 with a single prescription attribute or multiple prescription attributes.

In general, prescription attributes include attributes of the prescription and/or patient sent from the pharmacy administrator device 102 to the switching company device 110 that may be used to identify where prescription liability lies. Prescription attributes may include one or more of name of the patient, patient's address, patient's email address, patient's employer, patient ID number, employer's address, patient's health insurance identification number, name of pharmacy fulfilling the prescription, identification of pharmacy network, type of prescription drug, cost for fulfillment, and BIN no.

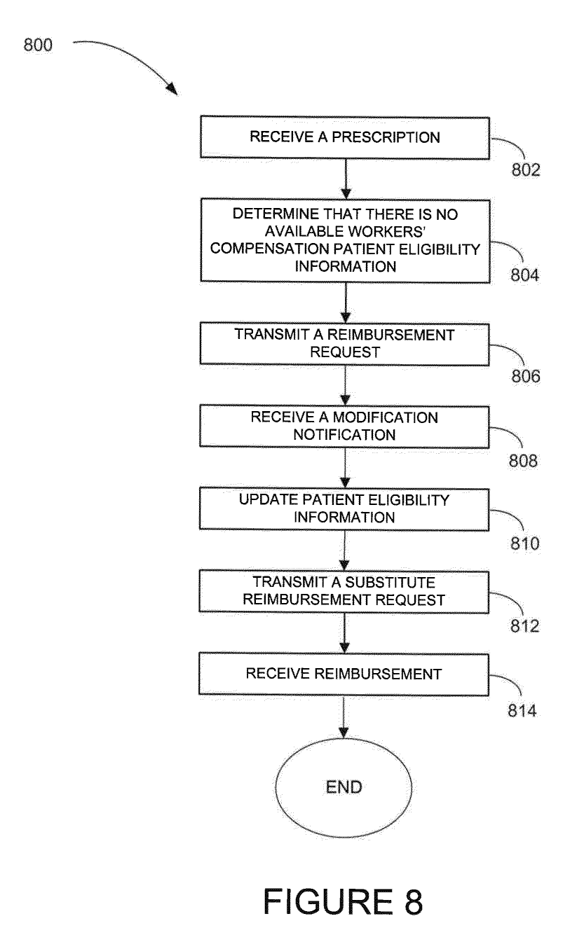

FIG. 8 illustrates a method 800 for prescription processing according to an example embodiment. The method 800 may be performed by the pharmacy administrative device 102, partially by the pharmacy administrative device 102 and partially by the claim assumer device 108, the benefit manager device 108, and/or the switching company device 110, or may be otherwise performed.

A prescription for a prescription drug to treat a worker for a work-related injury is received at block 802. The prescription may be received electronically (e.g., through a transmission), in paper (e.g., through a paper prescription written by the care provider), or otherwise. In some embodiments, receiving the prescription includes receiving the prescription for the prescription drug and identifying, based on the prescription, that the prescription drug is to treat the worker for a work-related injury.

A determination that there is no available workers' compensation patient eligibility information associated with the worker is made at block 804. In some embodiments, determining that there is no available workers' compensation patient eligibility information includes determining that there is no workers' compensation benefit manager associated with the worker and/or determining that there is no workers' compensation payor associated with the worker. In some embodiments, determining that there is no available workers' compensation patient eligibility information includes querying a database to determine that there is no available workers' compensation patient eligibility information associated with the worker.

A reimbursement request for filling of the prescription drug is transmitted to the claim assumer device 106 at block 806. In some embodiments, the reimbursement request includes a claim reimbursement responsibility identifier associated with the claim assumer.

A modification notification from the switching company device 110 is received at block 808 in response to transmission of the reimbursement request. The modification notification includes workers' compensation patient eligibility information associated with the worker.

Workers' compensation patient eligibility information associated with the worker is updated at block 810 in response to receipt of the modification notification. The updated workers' compensation patient eligibility information reflects a benefit manager to process workers' compensation claims.

At block 812, a substitute reimbursement request for the prescription drug is transmitted to the benefit manager device 108. In some embodiments, the substitute reimbursement request includes a benefit manager identifier associated with the benefit manager.

Reimbursement for the prescription drug is received at block 814 in response to transmission of the substitute reimbursement request.

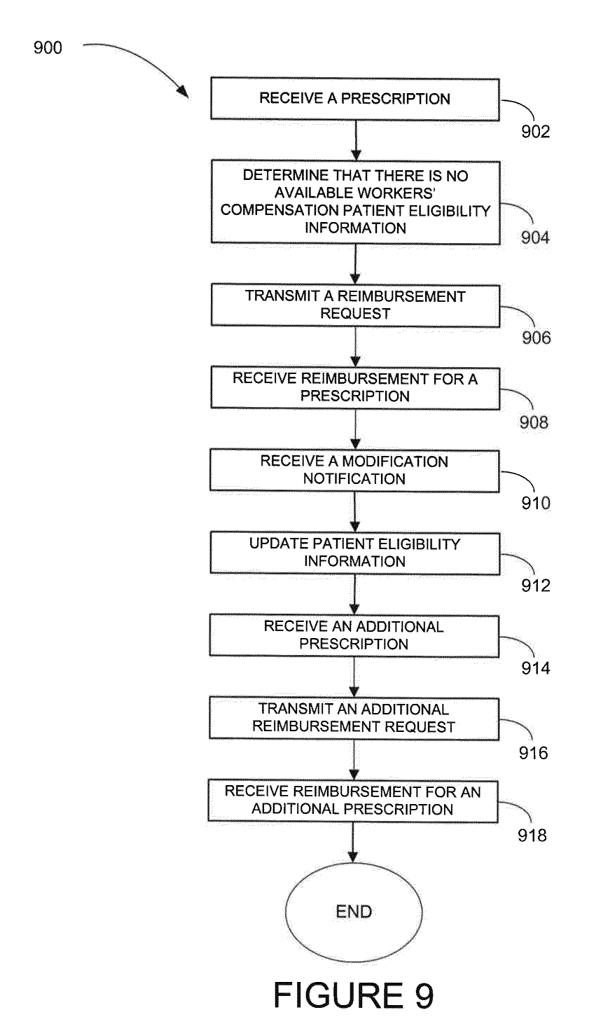

FIG. 9 illustrates a method 900 for prescription processing according to an example embodiment. The method 900 may be performed by the pharmacy administrative device 102, partially by the pharmacy administrative device 102 and partially by the claim assumer device 108, the benefit manager device 108, and/or the switching company device 110, or may be otherwise performed.

A prescription for a prescription drug to treat a worker for a work-related injury is received at block 902.

A determination that there is no available workers' compensation patient eligibility information associated with the worker is made at block 904.

A reimbursement request for filling of the prescription drug is transmitted at block 906. The reimbursement request may use or include an identifier associated with the claim assumer.

At block 908, reimbursement is received for the prescription drug in response to transmission of the reimbursement request. In some embodiments, the reimbursement is provided by the claim assumer.

After transmission of the identifier associated with the claim assumer, a modification notification is received at block 190 from the benefit manager device 108 including workers' compensation patient eligibility information associated with the worker.

At block 912, workers' compensation patient eligibility information associated with the worker is automatically updated in response to receipt of the modification notification. The updated workers' compensation patient eligibility information then reflects the benefit manager to process workers' compensation claims.

An additional prescription for a new additional prescription drug or a renewal of the prescription drug to treat the worker for the work-related injury is received at block 914. The additional prescription is prescribed (or filled) some period after the prescription (or filling) of the prior prescription.

A reimbursement request for filling of the new additional prescription drug or the renewal of the prescription drug is transmitted at block 916. In some embodiment, the reimbursement request uses or includes a benefit manager identifier.

At block 918, reimbursement for the new additional prescription drug or the renewal of the prescription drug is received in response to transmission of the reimbursement request.

In some embodiments, the filling pharmacy may contact various benefit managers and/or payors to determine eligibility in exchange for a higher reimbursement rate, additional reimbursement, or otherwise.

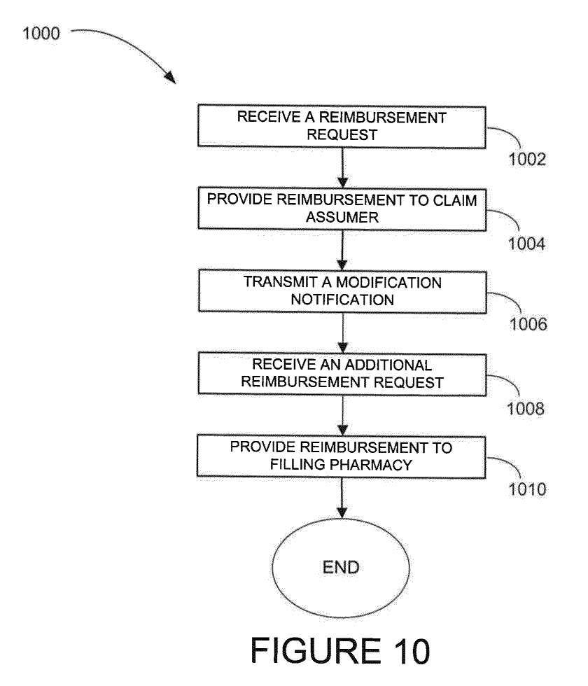

FIG. 10 illustrates a method 1000 for claim reimbursement according to an example embodiment. The method 1000 may be performed by the benefit manager device 108, partially by the benefit manager device 108 and partially by the pharmacy administrative device 102, the claim assumer device 108, and/or the switching company device 110, or may be otherwise performed.

A reimbursement request for filling of a prescription drug to treat a worker for a work-related injury is received at block 1002 from the claim assumer device 106.

At block 1004, reimbursement is provided to the claim assumer. The claim assumer has been reimbursed at a first reimbursement rate, while a filling pharmacy having filled the prescription drug has been reimbursed from the claim assumer at a second, different reimbursement rate. In some embodiments, the first reimbursement rate is higher than the second reimbursement rate.

After receiving the reimbursement request, a modification notification including workers' compensation patient eligibility information associated with the worker is transmitted at block 1006 to the pharmacy administrative device 102. In some embodiments, the pharmacy administrative device is capable of automatically updating workers' compensation patient eligibility information associated with the worker in response to receipt of the modification notification. The updated workers' compensation patient eligibility information reflects the benefit manager to process workers' compensation claims.

A reimbursement request for filling of a new additional prescription drug or a renewal of the prescription drug to treat the worker for the work-related injury is received at block 1008. In some embodiment, the reimbursement request uses or includes a benefit manager identifier. In some embodiments, the additional prescription is prescribed after the prescription.

At block 1010, reimbursement for the new additional prescription drug or the renewal of the prescription drug is provided in response to receipt of the reimbursement request. In some embodiments, the reimbursement is provided to the filling pharmacy (e.g., through a transmission to the pharmacy administrative device 102 associated with the filling pharmacy).

In some embodiments, the benefit manager may provide eligibility information for the injured worker to some or all of the pharmacies that meet a criterion (e.g., distance, time, etc.) from a location associated with the individual. The eligibility information may be provided before the first fill of a prescription drug of the injured worker, between the first fill of the prescription drug and a further prescription drug fill (e.g., a fill of another prescription or a refill of the prescription), or at a different time. Example locations associated with the criterion could include distance from a residence of the individual, a location of employment of the individual, and the like.

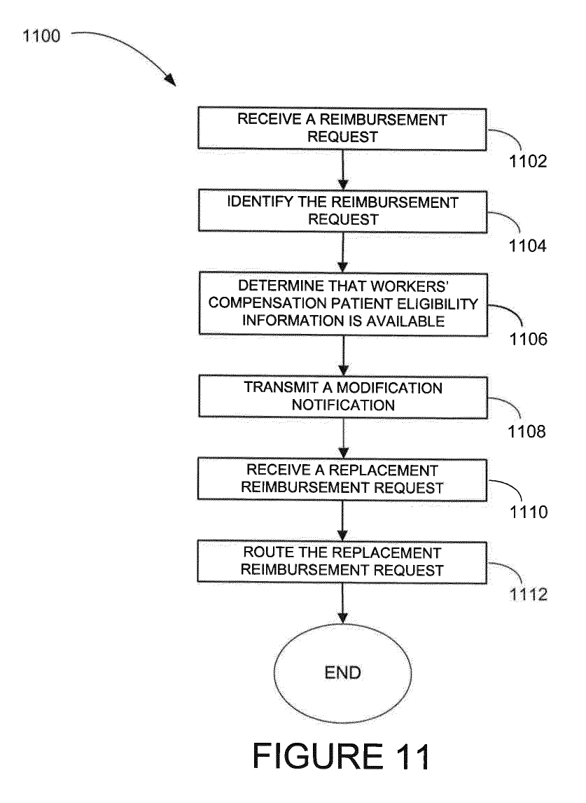

FIG. 11 illustrates a method 1100 for reimbursement routing according to an example embodiment. The method 1100 may be performed by the switching company device 110, partially by the switching company device 110 and partially by the pharmacy administrative device 102, the claim assumer device 106, and/or benefit manager device 108, or may be otherwise performed.

A reimbursement request for filling of a prescription drug on behalf of a worker is received at block 1102. In some embodiments, reimbursement request includes a claim reimbursement responsibility identifier. The reimbursement request is identified as being associated with a claim assumer at block 1104.

A determining that workers' compensation patient eligibility information is available for the worker is made at block 1106. At block 1108, a modification notification including workers' compensation patient eligibility information associated with the worker is transmitted to the pharmacy administrative device 102.

A replacement reimbursement request for filling of the prescription drug on behalf of the worker is received at block 1110. In some embodiments, the replacement reimbursement request includes a benefit manager identifier.

At block 1112, the replacement reimbursement request is routed to the benefit manager device 108 based on receipt of the replacement reimbursement request. In some embodiments, reimbursement is received from a benefit manager, a payor, or both the benefit manager and the payor based on routing of the replacement reimbursement request.

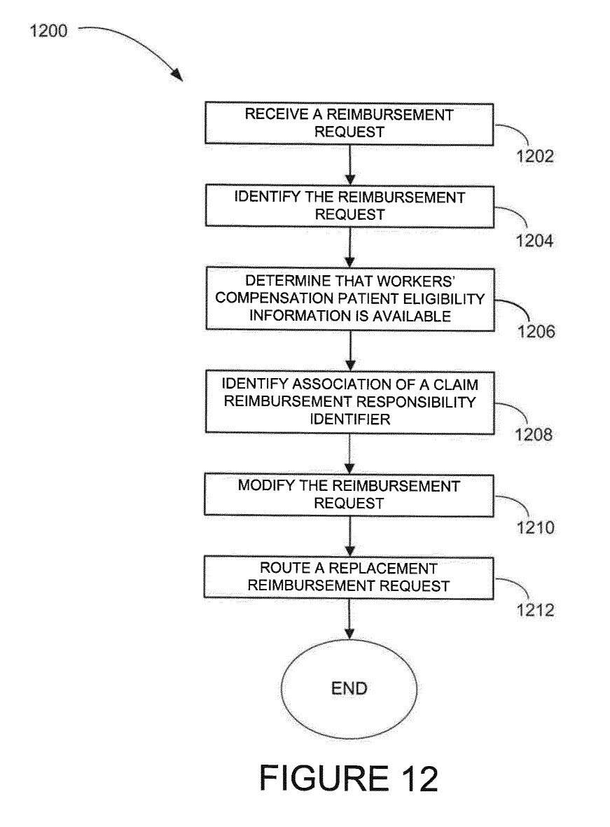

FIG. 12 illustrates a method 1200 for reimbursement routing according to an example embodiment. The method 1200 may be performed by the switching company device 110, partially by the switching company device 110 and partially by the pharmacy administrative device 102, the claim assumer device 106, and/or benefit manager device 108, or may be otherwise performed.

A reimbursement request for filling of a prescription drug on behalf of a worker is received at block 1202. In some embodiments, the reimbursement request includes or uses a claim reimbursement responsibility identifier.

At block 1204, the reimbursement request is identified as being associated with the claim assumer. In some embodiments, the claim reimbursement responsibility identifier of the reimbursement request is identified as being associated with the claim assumer.

A determining that workers' compensation patient eligibility information is available for the worker is made at block 1206.

At block 1208, the claim reimbursement responsibility identifier associated with the benefit manager may be identified based on the workers' compensation patient eligibility information associated with the worker.

The reimbursement request is modified at block 1210 to create a replacement reimbursement request that reflects that the reimbursement request is associated with a benefit manager. In some embodiments, the modification includes modifying the claim reimbursement responsibility identifier to reflect the benefit manager identifier.

The replacement reimbursement request is routed at block 1212 to the benefit manager device 108 associated with the benefit manager based on a modification to the reimbursement request. In some embodiments, reimbursement is received from the benefit manager, the payor, or both the benefit manager and the payor based on modification of the reimbursement request.

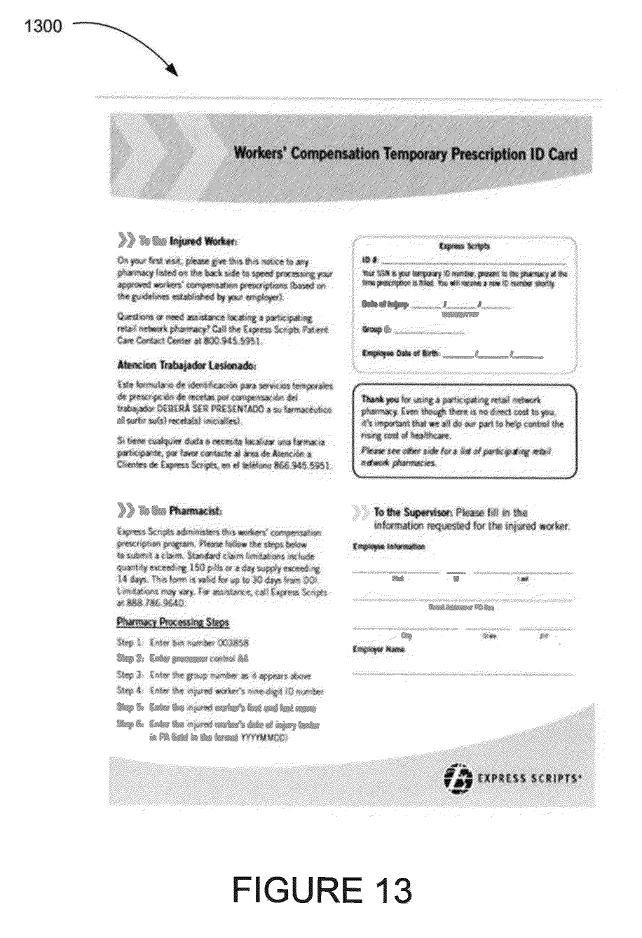

FIG. 13 is an example first fill form 1300, according to an example embodiment. The first fill form 1300 may be provided to the worker by the care provider, or may otherwise be provided to the worker.

As shown, the first fill form 1300 includes information the worker. For example, the first fill form 1300 may direct the worker in a single language or multiple languages to provide the document to an approved pharmacy. The list of approved pharmacies may be included on the opposite side (not shown) of the first fill form 1300. The first fill form 1300 may also direct the worker to contact a patient care center of the benefit manager for any questions or need for assistance in locating a participating retail network pharmacy.

The first fill form 1300 includes information for a pharmacist. In general, the injured worker would provide the first fill form 1300 to the pharmacist (or pharmacist technician) when seeking a first fill of a prescription after the injury has occurred. For example, the first fill form 1300 may advise of the benefit manager or administrator of the workers' compensation prescription program for the worker. The first fill form 1300 may also include instructions for submitting a claim for reimbursement. Example instructions that may be included on the first fill form 1300 include the following:

Please follow the steps below to submit a claim. Standard claim limitations include quantity exceeding 150 pills or a day supply exceeding 14 days. This form is valid for up to 30 days from DOI. Limitations may vary. For assistance, call Express Scripts at 888.786.9640.

Step 1: Enter bin number 003858
Step 2: Enter processor control A4
Step 3: Enter the group number as it appears above
Step 4: Enter the injured worker's nine-digit ID number
Step 5: Enter the injured worker's first and last name
Step 6: Enter the injured worker's date of injury (enter in PA field in the format YYYYMMDD)

The first fill form 1300 may include workers' compensation eligibility information for the worker. The included workers' compensation eligibility information may be used to input, or update, the eligibility information 120 of the worker in the pharmacy administrative database 122. An example of workers' compensation eligibility information that may be included on the first fill form 1300 is as follows:

### Express Scripts

### ID #: ______

Your SSN is your temporary ID number; present to the pharmacy at the time prescription is filled. You will receive a new ID number shortly.

### Date of Injury: ______/______/______

### MM/DD/YYYY

### Group #: ______

### Employee Date of Birth: ______/______/______

As the first fill form 1300 is generally completed by the supervisor of the injured worker or by a human resources representative, the first fill form 1300 may include a section for the supervisor (or human resources representative) to complete. An example section that may be included on the first fill form 1300 is as follows:

| | | |
|---|---|---|
| First Name | M | Last Name |

Street Address or PO Box

| | | |
|---|---|---|
| City | State | ZIP |

Employer Name

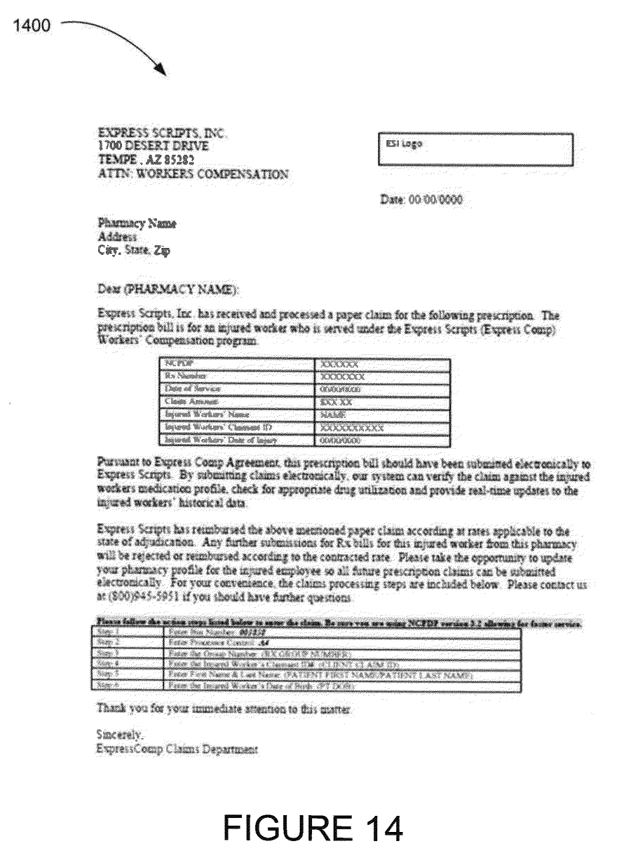

FIG. 14 is an example pharmacy letter 1400, according to an example embodiment. The pharmacy letter 1400 may be provided to the filling pharmacy to request that it update the workers' compensation patient eligibility information of the injured worker.

The pharmacy letter 1400 may identify the benefit manager associated with the injured worker. The pharmacy letter 1400 may identify that it has processed and received a claim (e.g., an electronic claim or a paper claim) for an identified prescription. For example, a prescription may be identified as follows:

### NCPDP XXXXXX

### Rx Number XXXXXXX

### Date of Service 00/00/0000

### Claim Amount $XX.XX

### Injured Workers' Name NAME

### Injured Workers' Claimant ID XXXXXXXXXX

### Injured Workers' Date of Injury 00/00/0000

The pharmacy letter 1400 may further direct the pharmacy regarding claim future submissions and the need to update its workers' compensation patient eligibility information for the injured worker. For example, the pharmacy letter 1400 may direct the pharmacist to electronically submit the claim to the benefit manager so that the benefit manager device 108 (or another device of the benefit manager) can verify the claim against the injured workers medication profile, check for appropriate drug utilization and provide real-time updates to the injured workers' historical data. The pharmacy letter 1400 may direct that further claims that are not submitted appropriately may be rejected or reimbursed according to a contracted rate between the benefit manager and the filling pharmacy.

The pharmacy letter 1400 may also instructions for claims processing that enables the pharmacy to be reimbursed for further prescription fills. For example, instructions may include the following:

### Step 1 Enter Bin Number: 003858

### Step 2 Enter Processor Control: A4

### Step 3 Enter the Group Number: (RX GROUP NUMBER)

### Step 4 Enter the Injured Worker's Claimant ID#: (CLIENT CLAIM ID)

### Step 5 Enter First Name & Last Name: (PATIENT FIRST NAME/PATIENT LAST NAME)

### Step 6 Enter the Injured Worker's Date of Birth: (PT DOB)

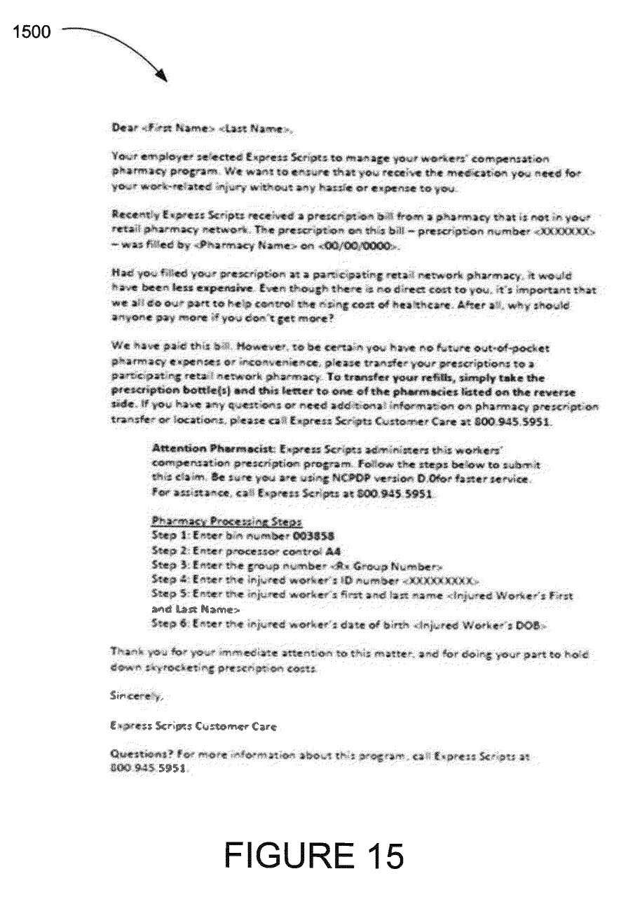

FIG. 15 is an example injured worker letter 1500, according to an example embodiment. The injured worker letter 1500 may be provided to the injured worker to request that the injured worker provide the appropriate workers' compensation patient eligibility information to a filling pharmacy.

The injured worker letter 1500 may identify the benefit manager. The injured worker letter 1500 may also provide information regarding a recently filled prescription under the workers' compensation benefit. For example, the injured worker letter 1500 may reflect the following:

Recently Express Scripts received a prescription bill from a pharmacy that is not in your retail pharmacy network. The prescription on this bill—prescription number <XXXXXXX>—was filled by <Pharmacy Name> on <00/00/0000>.

The injured worker letter 1500 may request the worker seek further prescription refills at a different pharmacy (e.g., a pharmacy in the retail network of the benefit plan of the worker's employer). The injured worker letter 1500 may also include information on how the pharmacy should process the claim for reimbursement.

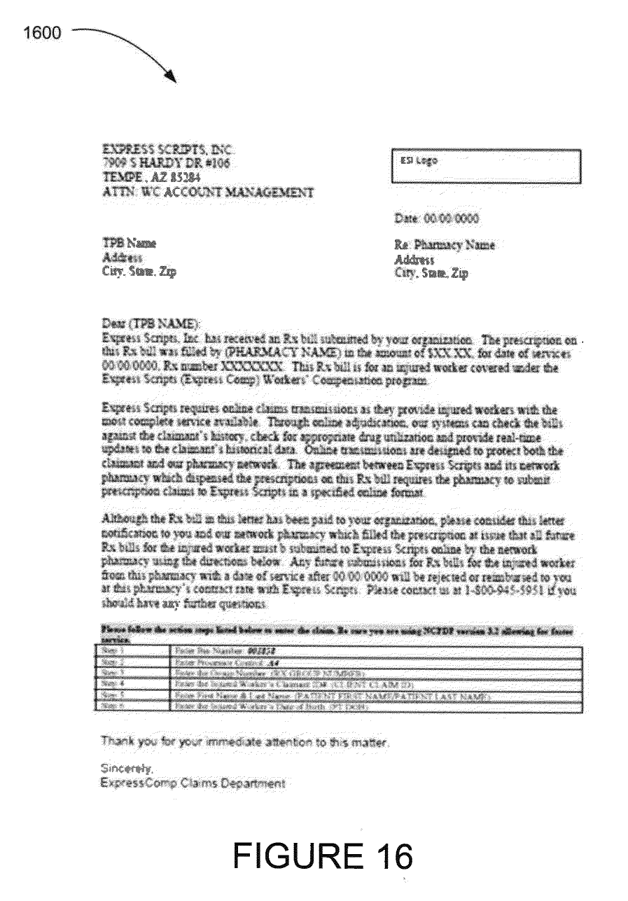

FIG. 16 is an example liability assumer letter 1600, according to an example embodiment. The liability assumer letter 1600 may be provided to the claim assumer to request that the claim assumer submit all future claims to the benefit manager in accordance with the workers' compensation eligibility information of the injured worker.

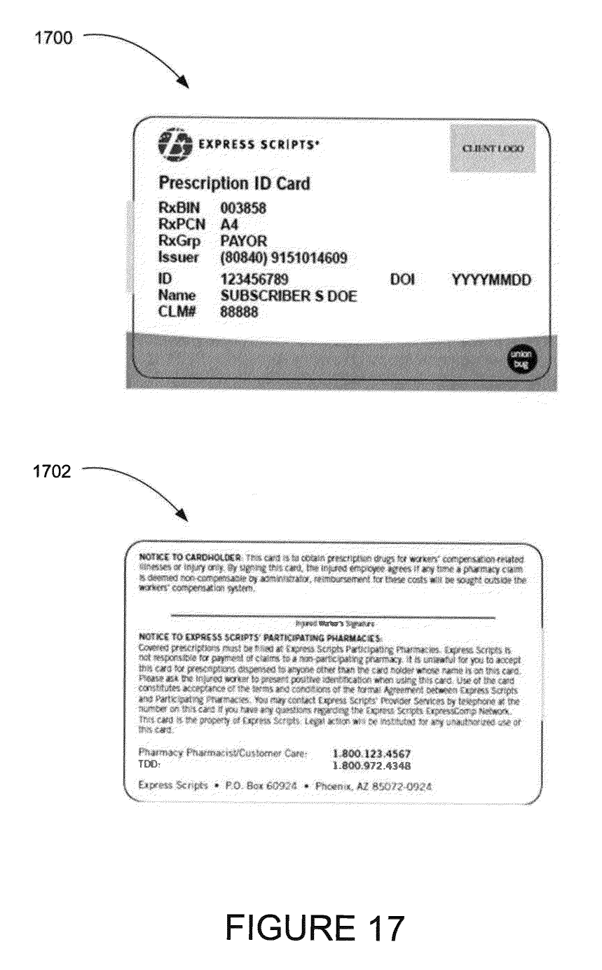

FIG. 17 includes an example injured worker ID card, according to an example embodiment. A first side 1700 of the injured worker ID card may include the following example fields: RxBIN, RxPCN, RxGrp, Issuer, ID Number, Injured Worker Name, Claim Number, and Date of Issue (DOI). A back side 1700 of the injured worker ID card may includes a notice to the injured worker and/or a notice to a filling pharmacy.

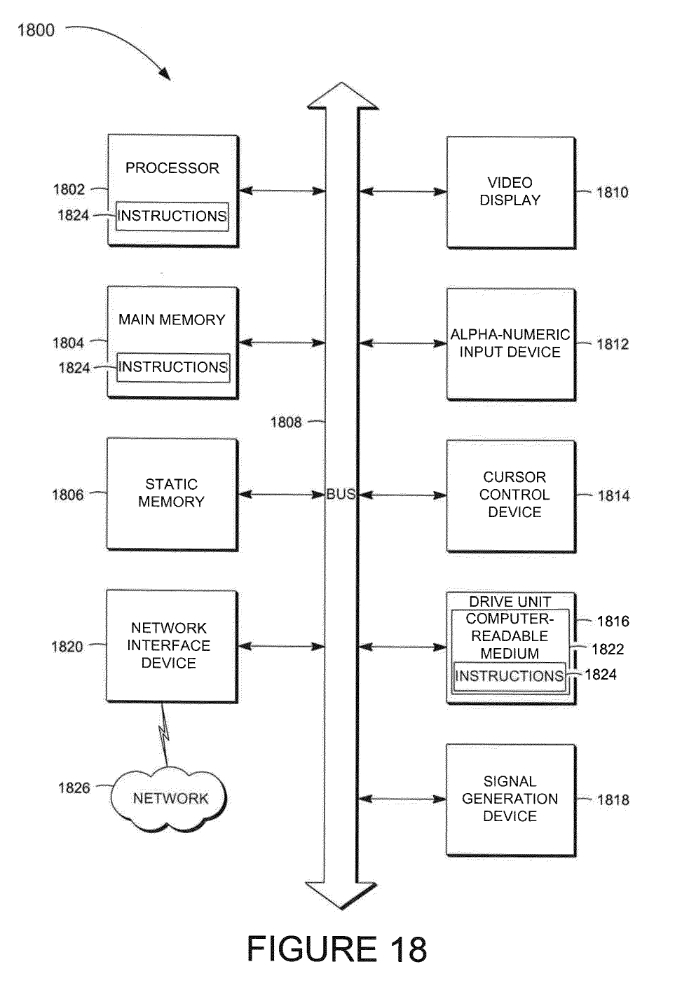

FIG. 18 shows a block diagram of a machine in the example form of a computer system 1800 within which a set of instructions may be executed causing the machine to perform any one or more of the methods, processes, operations, or methodologies discussed herein. The pharmacy administrative device 102, the claim assumer device 106, the benefit manager device 108, and/or the switching company device 110 may include the functionality of the one or more computer systems 1800.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a gaming device, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1812 (e.g., a central processing unit (CPU) a graphics processing unit (GPU) or both), a main memory 1804 and a static memory 1806, which communicate with each other via a bus 1808. The computer system 1800 further includes a video display unit 1810 (e.g., a liquid crystal display (LCD) or a cathode ray tube (CRT)). The computer system 1800 also includes an alphanumeric input device 1812 (e.g., a keyboard), a cursor control device 1814 (e.g., a mouse), a drive unit 1816, a signal generation device 1818 (e.g., a speaker) and a network interface device 1820.

The drive unit 1816 includes a computer-readable medium 1822 on which is stored one or more sets of instructions (e.g., software 1824) embodying any one or more of the methodologies or functions described herein. The software 1824 may also reside, completely or at least partially, within the main memory 1804 and/or within the processor 1812 during execution thereof by the computer system 1800, the main memory 1804 and the processor 1812 also constituting computer-readable media.

The software 1824 may further be transmitted or received over a network 1826 via the network interface device 1820.

While the computer-readable medium 1822 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present invention. The term “computer-readable medium” shall accordingly be taken to include, but not be limited to, solid-state memories, and optical media, and magnetic media. In some embodiments, the computer-readable medium is a non-transitory computer-readable medium.

The term “based on” or using, as used herein, reflects an open-ended term that can reflect others elements beyond those explicitly recited.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled.

The inventive subject matter may be represented in a variety of different embodiments of which there are many possible permutations.

In some embodiments, a reimbursement request for filling of a prescription drug on behalf of a worker is received. The reimbursement request is identified as being associated with a claim assumer. A determination that workers' compensation patient eligibility information is available for the worker is made. A modification notification including workers' compensation patient eligibility information associated with the worker is transmitted to a pharmacy administrative device. A replacement reimbursement request for filling of the prescription drug on behalf of the worker is received. The replacement reimbursement request is routed to a benefit manager device based on receipt of the replacement reimbursement request.

In some embodiments, a reimbursement request for filling of a prescription drug on behalf of a worker is received. The reimbursement request includes a claim reimbursement responsibility identifier. The claim reimbursement responsibility identifier of the reimbursement request is identified as being associated with a claim assumer. A determination is made that workers' compensation patient eligibility information is available for the worker. The claim reimbursement responsibility identifier associated with a benefit manager is identified based on the workers' compensation patient eligibility information associated with the worker. The reimbursement request including the reimbursement responsibility identifier is modified to reflect that the reimbursement request includes a benefit manager identifier. The replacement reimbursement request is routed to a benefit manager device associated with the benefit manager based on a modification to the claim reimbursement responsibility identifier.

In some embodiments, a prescription for a prescription drug to treat a worker for a work-related injury is received. A determination that there is no available workers' compensation patient eligibility information associated with the worker is made. A reimbursement request for filling of the prescription drug is transmitted to a claim assumer device. A modification notification from a switching company device is received in response to transmission of the reimbursement request. The modification notification includes workers' compensation patient eligibility information associated with the worker. Workers' compensation patient eligibility information associated with the worker is updated in response to receipt of the modification notification. The updated workers' compensation patient eligibility information reflects a benefit manager to process workers' compensation claims. A substitute reimbursement request for the prescription drug is transmitted to a benefit manager device. Reimbursement for the prescription drug is received in response to transmission of the substitute reimbursement request.

In some embodiments, a prescription for a prescription drug to treat a worker for a work-related injury is received. A determination that there is no available workers' compensation patient eligibility information associated with the worker is made. A reimbursement request for filling of the prescription drug is transmitted using an identifier associated with a claim assumer. Reimbursement for the prescription drug is received in response to transmission of the reimbursement request using the identifier associated with the claim assumer. After transmission of the identifier associated with the claim assumer, a modification notification is received from a benefit manager device including workers' compensation patient eligibility information associated with the worker. Workers' compensation patient eligibility information associated with the worker is automatically updated in response to receipt of the modification notification. The updated workers' compensation patient eligibility information reflects a benefit manager to process workers' compensation claims, the benefit manager being associated with the benefit manager device. An additional prescription is received for a new additional prescription drug or a renewal of the prescription drug to treat the worker for the work-related injury. The additional prescription is prescribed after the prescription. A reimbursement request for filling of the new additional prescription drug or the renewal of the prescription drug is transmitted using an identifier associated with the benefit manager. Reimbursement for the new additional prescription drug or the renewal of the prescription drug is received in response to transmission of the reimbursement request using the identifier associated with the benefit manager.

In some embodiments, a reimbursement request for filling of a prescription drug to treat a worker for a work-related injury is received, from a claim assumer device. The claim assumer device is a different device than a pharmacy filling device. Reimbursement is provided to a claim assumer associated with the claim assumer device. The claim assumer has been reimbursed at a first reimbursement rate. A filling pharmacy has filled the prescription drug having been reimbursed from the claim assumer at a second reimbursement rate. The first reimbursement rate is higher than the second reimbursement rate. After receiving the reimbursement request, a transmission of a modification notification including workers' compensation patient eligibility information associated with the worker through a computer network to a pharmacy administrative device. the pharmacy administrative device being capable of automatically updating workers' compensation patient eligibility information associated with the worker in response to receipt of the modification notification, the updated workers' compensation patient eligibility information reflecting a benefit manager to process workers' compensation claims. A reimbursement request for filling of a new additional prescription drug or a renewal of the prescription drug to treat the worker for the work-related injury uses an identifier associated with the benefit manager and is received after the additional prescription being prescribed after the prescription. Reimbursement is provided for the new additional prescription drug or the renewal of the prescription drug in response to receipt of the reimbursement request using the identifier associated with the benefit manager.

Thus, methods and systems for managing prescription liability have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

The methods described herein do not have to be executed in the order described, or in any particular order. Moreover, various activities described with respect to the methods identified herein can be executed in serial or parallel fashion. Although “End” blocks are shown in the flowcharts, the methods may be performed continuously.

1. A method comprising:
receiving a reimbursement request for filling of a prescription drug on behalf of a worker;
identifying the reimbursement request as being associated with a claim assumer;
determining that workers' compensation patient eligibility information is available for the worker;
transmitting a modification notification including workers' compensation patient eligibility information associated with the worker to a pharmacy administrative device;
receiving a replacement reimbursement request for filling of the prescription drug on behalf of the worker; and
routing the replacement reimbursement request to a benefit manager device based on receipt of the replacement reimbursement request.

2. The method of claim 1, wherein the reimbursement request includes a claim reimbursement responsibility identifier and the replacement reimbursement request includes a benefit manager identifier.

3. The method of claim 2, further comprising:
receiving reimbursement from a benefit manager, a payor, or both the benefit manager and the payor based on routing of the replacement reimbursement request.

4. A method comprising:
receiving a reimbursement request for filling of a prescription drug on behalf of a worker, the reimbursement request including a claim reimbursement responsibility identifier;
identifying the claim reimbursement responsibility identifier of the reimbursement request as being associated with a claim assumer;
determining that workers' compensation patient eligibility information is available for the worker;
identifying the claim reimbursement responsibility identifier associated with a benefit manager based on the workers' compensation patient eligibility information associated with the worker;
modifying the claim reimbursement responsibility identifier associated with the reimbursement request to reflect that the reimbursement request is associated with a benefit manager; and
routing the replacement reimbursement request to a benefit manager device associated with the benefit manager based on a modification to the claim reimbursement responsibility identifier.

5. The method of claim 4, further comprising:
receiving reimbursement from a benefit manager, a payor, or both the benefit manager and the payor based on modification of the claim reimbursement responsibility identifier associated with the reimbursement request to reflect that the reimbursement request is associated with the benefit manager.

6. The method of claim 4, wherein the prescription drug is to treat a work-related injury incurred by the worker.

7. A method comprising:
receiving a prescription for a prescription drug to treat a worker for a work-related injury;
determining that there is no available workers' compensation patient eligibility information associated with the worker;
transmitting a reimbursement request for filling of the prescription drug to a claim assumer device;
receiving a modification notification from a switching company device in response to transmission of the reimbursement request, the modification notification including workers' compensation patient eligibility information associated with the worker;
updating workers' compensation patient eligibility information associated with the worker in response to receipt of the modification notification, the updated workers' compensation patient eligibility information reflecting a benefit manager to process workers' compensation claims;
transmitting a substitute reimbursement request for the prescription drug to a benefit manager device; and
receiving reimbursement for the prescription drug in response to transmission of the substitute reimbursement request.

8. The method of claim 7, wherein the reimbursement request includes a claim reimbursement responsibility identifier associated with a claim assumer and a substitute reimbursement request includes a benefit manager identifier associated with the benefit manager.

9. The method of claim 7, wherein receiving the prescription comprises:
receiving the prescription for the prescription drug; and
identifying, based on the prescription, that the prescription drug is to treat the worker for a work-related injury.

10. The method of claim 7, wherein receiving the prescription comprises:
receiving an electronic transmission of the prescription for the prescription drug.

11. The method of claim 7, wherein determining that there is no available workers' compensation patient eligibility information comprises:
determining that there is no workers' compensation benefit manager associated with the worker; and
determining that there is no workers' compensation payor associated with the worker.

12. The method of claim 7, wherein determining that there is no available workers' compensation patient eligibility information comprises:
querying a database to determine that there is no available workers' compensation patient eligibility information associated with the worker.
